(19) United States
(12) Patent Application Publication
(10) Pub. No.: US 2014/0089389 A1
(43) Pub. Date: Mar. 27, 2014

(54) METHOD AND APPARATUS FOR PROVIDING WEB-BASED MULTI-NETWORK ADAPTIVE MULTI-SCREEN SERVICE

(71) Applicant: Electronics and Telecommunications Research Institue, (US)

(72) Inventors: Jae-Ho Kim, Gyeryong (KR); Chang-Ki Kim, Daejeon (KR); Tae-Jung Kim, Cheongju (KR); Jeong-Ju Yoo, Daejeon (KR); Jin-Woo Hong, Daejeon (KR)

(73) Assignee: Electronics and Telecommunications Research Institute, Daejeon (KR)

(21) Appl. No.: 13/797,524

(22) Filed: Mar. 12, 2013

(30) Foreign Application Priority Data
Sep. 25, 2012 (KR) 10-2012-0106659

(51) Int. Cl. H04L 29/06

(52) U.S. Cl. CPC H04L 67/42
USPC 709/203

(57) ABSTRACT

An apparatus and a method for providing a web-based multi-network adaptive multi-screen service are provided. According to an exemplary embodiment of the present invention, a multi-screen server, a smart device providing a multi-screen and multi-networks are associated with each other to provide a multi-screen service.

### CROSS-REFERENCE TO RELATED APPLICATION

This application claims the benefit under 35 U.S.C. §119(a) of Korean Patent Application No. 10-2012-0106659, filed on Sep. 25, 2012, the entire disclosure of which is incorporated herein by reference for all purposes.

### BACKGROUND

1. Field

The present invention relates to a broadcasting and communication technology, and, more specifically, a content media service technology using various devices

2. Description of the Related Art

A smart device is an electronic device that is connected to the Internet via a wired or wireless network and is capable of internet browsing and multiple functions. It is now considered by many as a necessity of daily life. Such smart device includes a smart phone, a smart pad and a smart TV.

The smart device is so widely popular that many people possess two or more smart devices. Naturally, the users wish to use two or more devices at the same time. Such a technology is called a multi-screen service technology. A multi-screen is a group of various smart devices belonging to a user, and a multi-screen service refers to a service of providing a piece of content using the multi-screen.

Using the multi-screen technology, a content provider allows a user to enjoy the same piece of content with various smart devices and the same User Experience (UX). In other words, the multi-screen technology enables the user to consume a piece of content provided by the content provider on a smart device that he or she wishes to use, including a smart TV, a smart phone and a smart pad. In addition, a network operator is capable of utilizing network resources more efficiently due to the multi-screen service technology.

### SUMMARY

The following description relates to a method for providing a web-based application adaptive to the various smart devices of a user, migrating an application from one smart device into another, and remote-controlling the migrated application using the former smart device.

In one general aspect of the present invention, a smart device is provided, and the smart device comprises a multi-screen service application (App) configured to execute a multi-screen service; a web browser configured to communicate with a multi-screen server; a multi-screen service unit included in the web browser; an Application Programming Interface (API) included in the multi-screen service and configured to execute the multi-screen service unit; and a hybrid network receiver configured to receive a piece of content from a multi-screen server via multi-networks. The multi-screen service may mean providing a service including the piece of content through a multi-screen, and the multi-screen may be a group of screens belonging to a plurality of the smart devices.

The multi-screen service unit may include a service discovery interface configured to discover a different smart device which provides the multi screen service on a same network as that of the smart device; a service description exchange interface configured to help the smart devices to exchange a description about the multi-screen service; a service migration interface configured to allow the multi-screen service to be migrated between the smart devices accessing the same network; and a service remote-control interface configured to enables a source smart device to remote-control a multi-screen service which has been migrated to a target smart device.

The service discovery interface may discover a multi-screen service provided by the different smart device, when the different smart device accessing the same network in the surroundings of the smart device receives a multicast advertisement message. In addition, the service discovery interface may discover the multi-screen service provided by the different smart device accessing the same network by periodically transmitting a multicast search message to request a search among surrounding smart devices and receiving a corresponding search response message.

The smart device of claim 3, wherein the multi-screen service Apps of the smart devices accessing the same network may exchange a service migration request message and a migration response message with each other and transmit and/or receive the service migration request message with respect to the multi-screen service server.

The hybrid network receiver may receive a content request response message, comprising a URL of the requested piece of content, from the multi-screen service server through the multi-screen service App, and receives the request piece of content from the multi-screen service server with reference to the URL.

A multi-screen service App of the source smart device may transmit a service remote-control command to the target smart device to remote-control both the migrated multi-screen service and the target smart device, thereby enabling the source smart device to remote-control the multi-screen service which has been migrated into the target smart device.

The service remote-control command may include a device control command to control the target smart device and a service-server control command to control the multi-screen service server. A multi-screen service App of the target smart device may transmit the device control command received from the source device to a multi-screen service unit thereof, and the multi-screen service unit controls the target smart device according to the device control command and reports a result of controlling the target smart device to the multi-screen service App of the target smart device.

The smart device may further include a hierarchical decoder configured to decode a multiple-layered piece of content, wherein the hybrid network receiver receives the multiple-layered pieces of content from the multi-screen service server via the multi-networks, synchronizes the received multiple-layered pieces of content, and then transmits the synchronized multiple-layered pieces of content to the hierarchical decoder.

In another general aspect of the present invention, a method for providing a multi-screen service in a smart device is provided, and the method includes exchanging a service description about a multi-screen service by discovering the multi-screen service provided by a different smart device accessing a same network as that of a smart device; requesting that the multi-screen service server migrate the multi-screen service and then receiving a content request response message comprising a URL of a requested piece of content to thereby continuously receive the requested piece of content currently being provided by the different smart device which has exchanged the service description; and receiving the requested piece of content from the multi-screen service server via the multi-networks using the URL and reproducing the received piece of content.

In another general aspect of the present invention, a method for providing a multi-screen service in a smart device is provided, and the method includes receiving a service remote-control command from a source smart device to control a different smart device; controlling the smart device and a multi-screen service server according to the received remote-control command; and transmitting to the source smart device a result of a service status changed by the control of the smart device and the multi-screen service server.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a multi-screen service system in association with web-based multi-networks according to an exemplary embodiment of the present invention;

FIG. 2 is a hierarchical configuration of a multi-screen service system which is association with web-based multi-networks;

FIG. 3 is a diagram illustrating in detail a configuration of a multi-screen service Application Programming Interface (API) according to an exemplary embodiment of the present invention;

FIG. 4 is a referential diagram illustrating an example of how to use a multi-screen service User Interface (UI) according to an exemplary embodiment of the present invention;

FIG. 5 is a flow chart illustrating a process for executing a multi-screen service according to an exemplary embodiment of the present invention;

FIG. 6 is a flow chart illustrating a process for discovering a multi-screen service and transmitting a description about the multi-screen according to an exemplary embodiment of the present invention;

FIG. 7 is a flow chart illustrating a process for migrating a multi-screen service according to an exemplary embodiment of the present invention; and

FIG. 8 is a flow chart illustrating a process for remote-controlling a multi-screen service according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

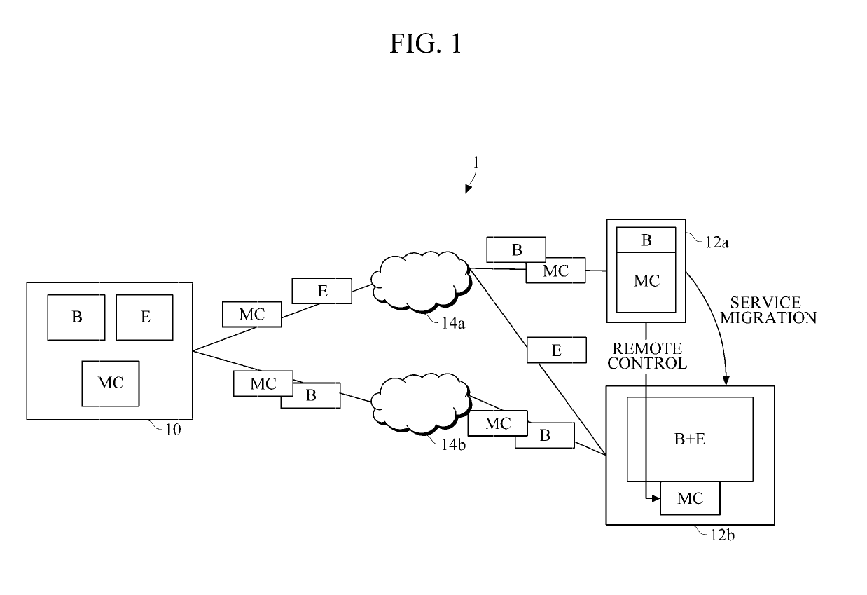

FIG. 1 is a diagram illustrating a configuration of a multi-screen service system in association with web-based multi-networks according to an exemplary embodiment of the present invention.

Referring to FIG. 1, the multi-screen service system 1 includes a web streaming server 10, networks and smart devices.

A plurality of networks are provided in the present invention. Although only an internet network 14a and a broadcasting network 14b are illustrated in FIG. 1, the present invention is not limited thereto. Similarly, a plurality of smart devices are provided. To give more understanding about the configuration and operation of the present invention, an exemplary embodiment where the web-streaming server 10 provides a user with a multi-screen service via a mobile smart device 12a and a smart TV 12b is shown in FIG. 1. Hereinafter, the mobile smart device 12a and the smart TV 12b will be described as examples of the smart device for the sake of explanation, but they is merely exemplary and the smart device may include others.

In the present invention, a multi-screen indicates a group of screens of various smart devices belonging to a user, while a multi-screen service is providing a piece of content and the like to a multi-screen of smart devices via multi-networks. At this time, a multi-screen service is able to be provided either to a single smart device or to a plurality of smart devices concurrently. In addition, it is also possible to migrate a multi-screen service currently being provided from one smart device to another. Furthermore, a smart device is able to remote-control a multi-screen service on a different smart device. A piece of content may include voice, a video, an image and other media, or may be multimedia configured as a combination of the above examples.

FIG. 1 is illustrated to show an example of providing a multi-screen service. Referring to FIG. 1, the web-streaming server 10 provides a piece of content to the mobile smart device 12a and the smart TV 12b via multi-networks including the Internet network 14a and the broadcasting network 14b. The piece of content transmitted from the web-streaming server 10 may be hierarchically encoded to be adaptive to the accessed networks and each screen size of the smart devices 12a and the smart TV 12b. At this time, the mobile smart device 12a may reproduce the piece of content with a standard resolution (for example, Standard-Definition (SD) resolution) by receiving a base layer (b) via the Internet network 14a.

According to an exemplary embodiment of the present invention, a multi-screen service, which is currently being provided on one smart device, may be migrated to another smart device. For example, as illustrated in FIG. 1, a user is able to receive a multi-screen service, which was provided shortly before on the mobile smart device 12a, through the smart TV 12b belonging to the same network as that of the mobile smart device 12a. In this case, the smart TV 12b may receive a base layer B via the broadcasting network 14b and an enhancement layer E from the web streaming server 10 via the Internet network 14a. Next, the smart TV 12b may reproduce a piece of content with an improved resolution (for example, a High-Definition (HD) resolution and/or a three-dimensional (3D) resolution) on a screen thereof by synchronizing the base layer B and the enhancement layer E.

According to an exemplary embodiment of the present invention, a source smart device remote-controls a target smart device. For example, as illustrated in FIG. 1, a user uses the mobile smart device 12a as a remote controller of the smart TV 12b. That is, the mobile smart device 12a is able to remote-control a multi-screen service migrated into the smart TV 12b. In FIG. 1, MC indicates a multi-screen control document.

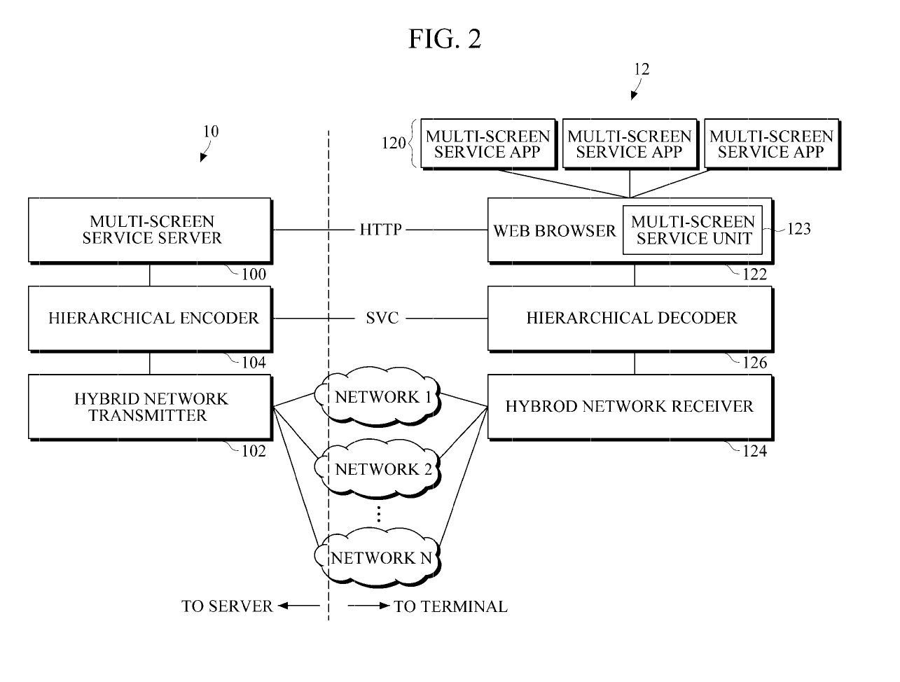

FIG. 2 is a diagram illustrating a hierarchical configuration of the multi-screen service system 1 which accesses web-based multi-networks.

Referring to FIG. 2, the web streaming server 10 includes a multi-screen service server 100, a hierarchical encoder 104 and a hybrid network transmitter 102, while the smart device 12 includes a multi-screen service application (App) 120, a web browser 122, a hierarchical decoder 126 and a hybrid network receiver 124.

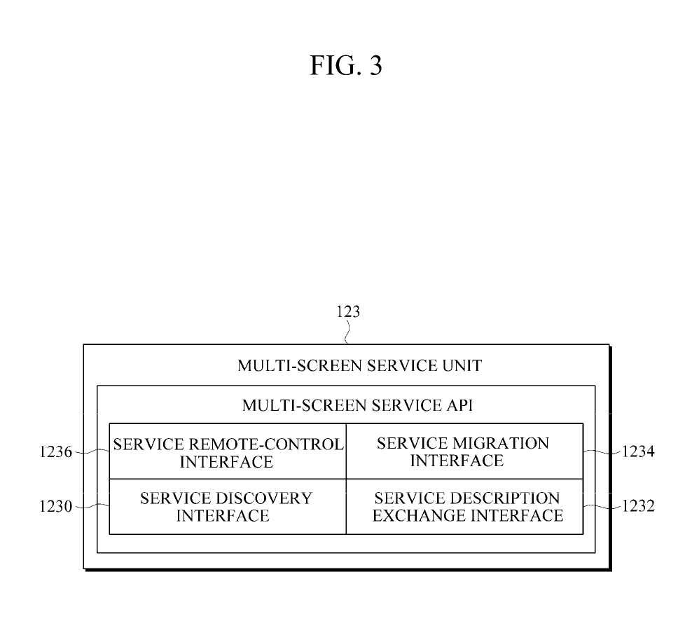

On the highest network layer, the web-based multi-screen service server 100 of the web streaming server 10 and the web browser 122 of the smart device 12 communicate with each other using a standard web transfer protocol, such as Hyper Text Transfer Protocol (HTTP). A multi-screen service unit 123 included in an expanded version of the web browser 122 provides a multi-screen service Application Programming Interface (API). The multi-screen service App 120 needs to include the multi-screen service API to execute a multi-screen service. The multi-screen service API will be described in detail with reference to FIG. 3.

The hierarchical encoder 104 of the web-streaming server 10 encodes a piece of content into multiple layers to be adaptive to a multi-screen of the smart device 12 whereby the piece of content is able to be transmitted to the hierarchical decider 126 of the smart device 12 using HTTP or Real-time Transfer Protocol (RTP). At this time, Scalable Video Encoding (SVC) may be employed in the hierarchically encoding process. As being encoded in the above manner, the piece of content may be transmitted to the hierarchical decoder 126 of the smart device 12 using HTTP or Real-time Transfer Protocol (RTP). The hierarchical decoder 126 of the smart device 12 decodes the piece of content which has been encoded into multi-layers. That is, the hybrid network transmitter 102 transmits hierarchically encoded pieces of content to the smart device 12 via multi-networks concurrently. In response to receiving the hierarchically encoded pieces of content from the hybrid network transmitter 102 via the multi-networks, the hybrid network receiver 124 synchronizes the hierarchically encoded pieces of content and then transmits the hierarchically encoded pieces of content, which have been synchronized, to the hierarchical decoder 126.

FIG. 3 is a diagram illustrating in detail a configuration of a multi-screen service API according to an exemplary embodiment of the present invention.

Referring to FIG. 3, the multi-screen service API includes one or more of a service discovery interface 1230, a service description exchange interface 1232, a service migration interface 1234 and a service remote-control interface 1236.

The service discovery interface 1230 discovers a different smart device accessing the same network as that of a corresponding smart device, which provides a multi-screen service. The service description exchange interface 1232 helps smart devices to exchanges a description about the multi-screen service description. The service migration interface 1234 continuously migrates a multi-screen service from the smart device to the different smart device. The service remote-control interface 1236 enables a source smart device to remote-control a multi-screen service which has been migrated into a target smart device.

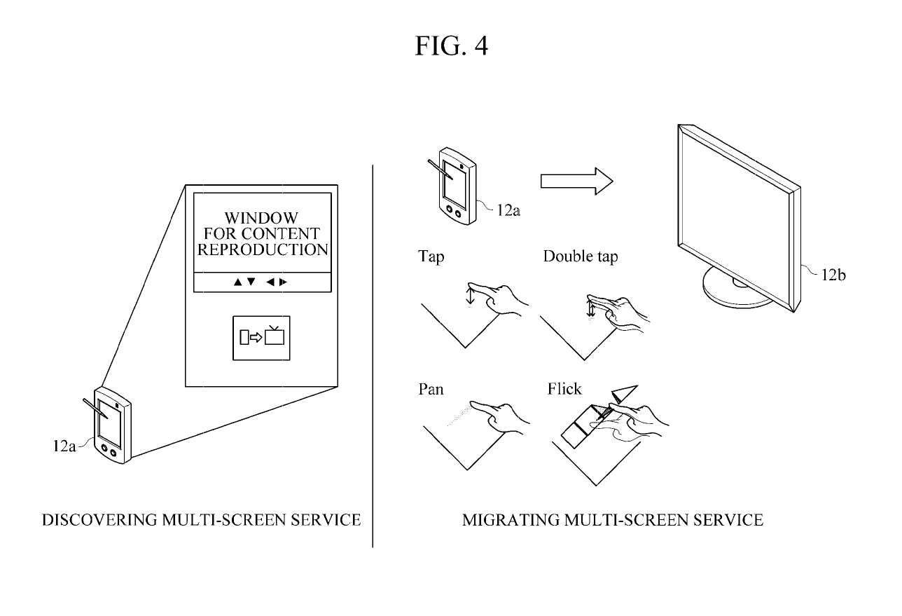

FIG. 4 is a referential diagram illustrating an example of how to use a multi-screen service User Interface (UI) according to an exemplary embodiment of the present invention.

The multi-screen service UI implemented on a smart device includes a content reproducing window, a media reproduction controlling UI and a multi-screen service UI. If discovering a smart TV 12b which provides a multi-screen service on the same network, using a multi-screen service API, the multi-screen service UI informs a user of the discovery of the multi-screen service.

Using the multi-screen service UI, a user is able to migrate the multi-screen service from a mobile smart device 12a to the smart TV 12b. Generally, a user is able to check a list of smart TVs, which are discovered on a network, using a combination of touch UIs on the mobile smart device 12a that supports a touch screen, and to migrate a multi-screen service from the smart device 12a to the smart TV 12b. The combination of the touch UIs may include tap, double tap, pan and flick.

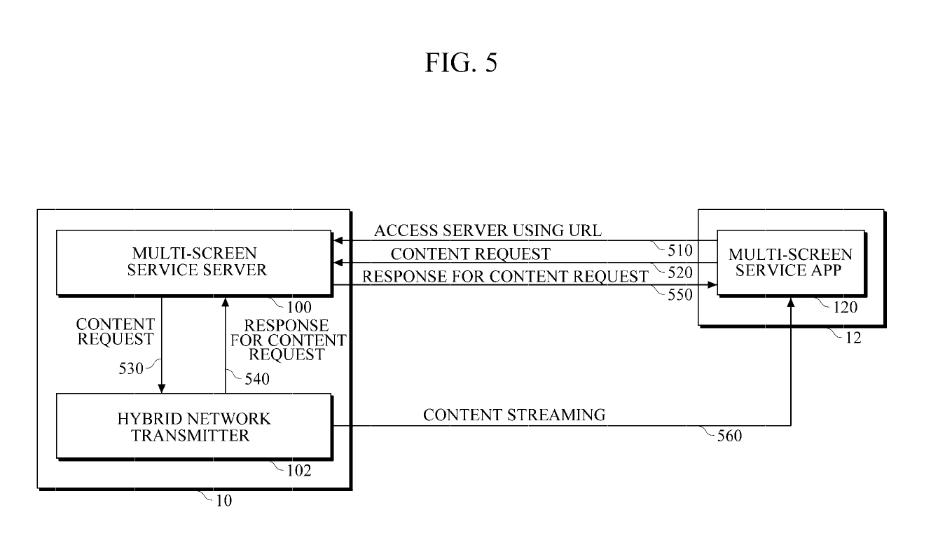

FIG. 5 is a flow chart illustrating a process for implementing a multi-screen service according to an exemplary embodiment of the present invention.

Referring to FIG. 5, a user accesses a multi-screen server 100 using a multi-screen App 120 of a smart device 12 in 510. At this time, the multi-screen server 100 and the smart device 12 communicate with each other using HTTP, and the smart device 12 is able to transmit network interface information (Net_IF-Info) and a screen size thereof to the multi-screen service server 100.

Next, if a user selects a piece of content using a UI of the multi-screen service App 120, the multi-screen service App 120 transmits a content request message including a content identification (ID) of the requested piece of content to the multi-screen service App 120 in 520. The multi-screen service server 100 transmits the network interface information, the screen size and the content ID to the hybrid network transmitter 102 in 530.

The hybrid network transmitter 102 transmits a content request response message including a URL of the requested piece of content to the multi-screen service server 100 in 540, and then the multi-screen service server 100 transmits the content request response message to the smart device 12 in 550. Next, the multi-screen service App 120 receives the requested piece of content by requesting that the hybrid network transmitter transmits a stream of the requested piece of content with reference to the URL, and reproduces the stream in 560.

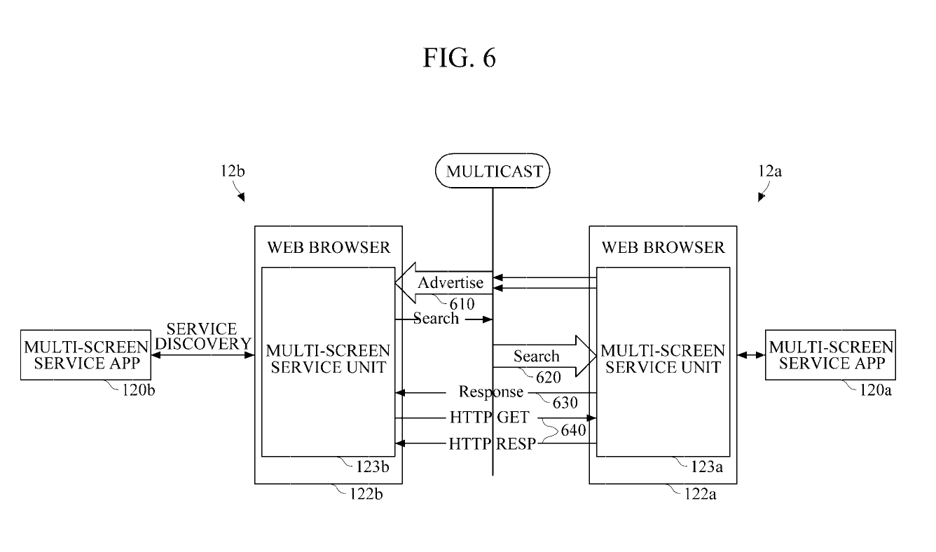

FIG. 6 is a flow chart illustrating a process for discovering a multi-screen service and exchanging a description about a multi-screen service according to an exemplary embodiment of the present invention.

Referring to FIG. 6, the smart device 12a transmits a multicasting advertisement message to advertise discovery of a new network or the availability of a multi-screen service in 610. The advertisement may be performed periodically. The smart TV 12b is able to discover a multi-screen service by receiving the advertisement message from the mobile smart device 12a or by periodically transmitting a multicast search message to request a search among surrounding multi-screen service devices in 620, and then receiving a corresponding search response message in 630. Next, after the multi-screen service is discovered, the mobile smart device 12a and the smart TV 12b are able to exchange a description about the multi-screen service with each other in 640. A multi-screen service function for discovering a multi-screen service and transmitting a description thereof is supported by a multi-screen service API of the multi-screen service unit included in the web browser. The service discovery result is transmitted to a multi-screen service App 120b via a web browser.

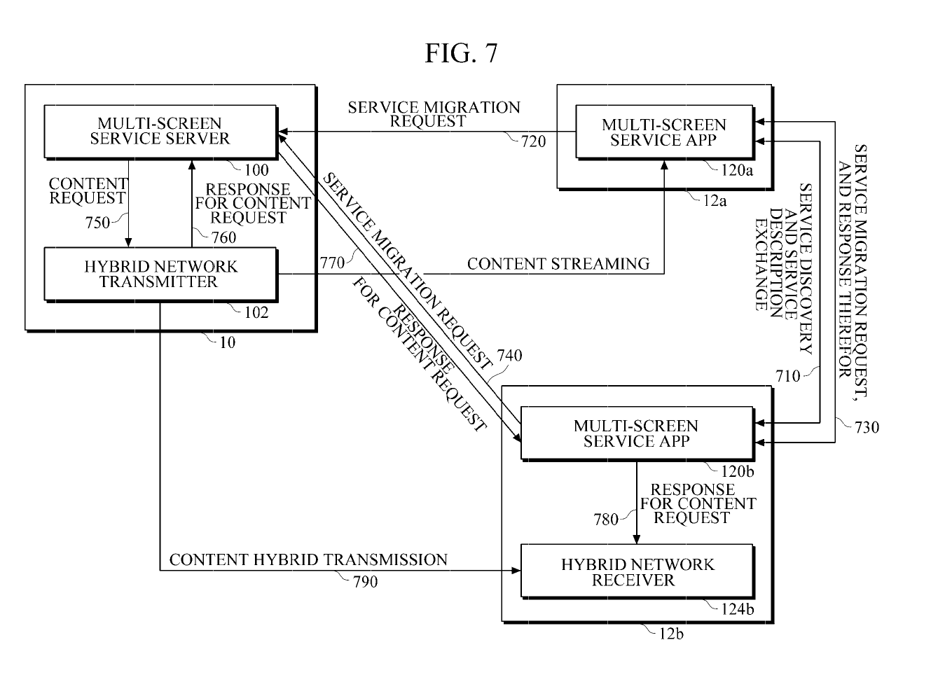

FIG. 7 is a flow chart illustrating a process for migrating a multi-screen service according to an exemplary embodiment of the present invention.

Referring to FIG. 7, if a user wants to migrate a multi-screen service from a mobile smart device 12a into a smart TV 12b when enjoying the multi-screen service on the mobile smart device 12a, the mobile smart device 12a discovers the smart TV 12b on the same network as that of the mobile smart device 12a and then exchanges a description about the multi-screen service with the discovered smart TV 12b in 710. The process for discovering a multi-screen service and exchanging a service description is the same as described above with reference to FIG. 6. Next, if receiving a request for multi-screen service migration from a user using the multi-screen service UI, the mobile smart device 12a transmits a service migration request message to a multi-screen service server 1000 in 720. The service migration request message includes service context of the multi-screen service which is currently being provided. The service context of the multi-screen service includes a user identification (ID), an identification of a piece of content and a playback position of a service.

Next, between multi-screen service App 120a and 120b of the mobile smart device 12a and the smart TV 12b, respectively, the service migration request message is transmitted and a corresponding migration response message is received in 730. A multi-screen service unit of a web browser allows the transmission and reception of the service migration request message and the migration response message. Next, the multi-screen service App 120b of the smart TV 12b transmits to the multi-screen service server 100 the service context along with the network interface information and a screen size of the smart TV 12b in 740.

The multi-screen service server 100 transmits the service context, the network interface information and the screen size to a hybrid network transmitter 102 in 750. Next, the hybrid network transmitter 102 transmits a content request response message including a URL of a requested piece of content and a channel ID to the multi-screen service server 100 in 760, and then the content request response message is transmitted to the multi-service screen App 120b of the smart TV 12b in 770. Next, the multi-screen service App 120b of the smart TV 12b transmits the content request response message including the URL of the requested piece of content and the channel ID to a hybrid network receiver 124 in 780, and the hybrid network receiver 124 receives a stream of the requested piece of content via multi-networks from the hybrid network transmitter 102 in 790.

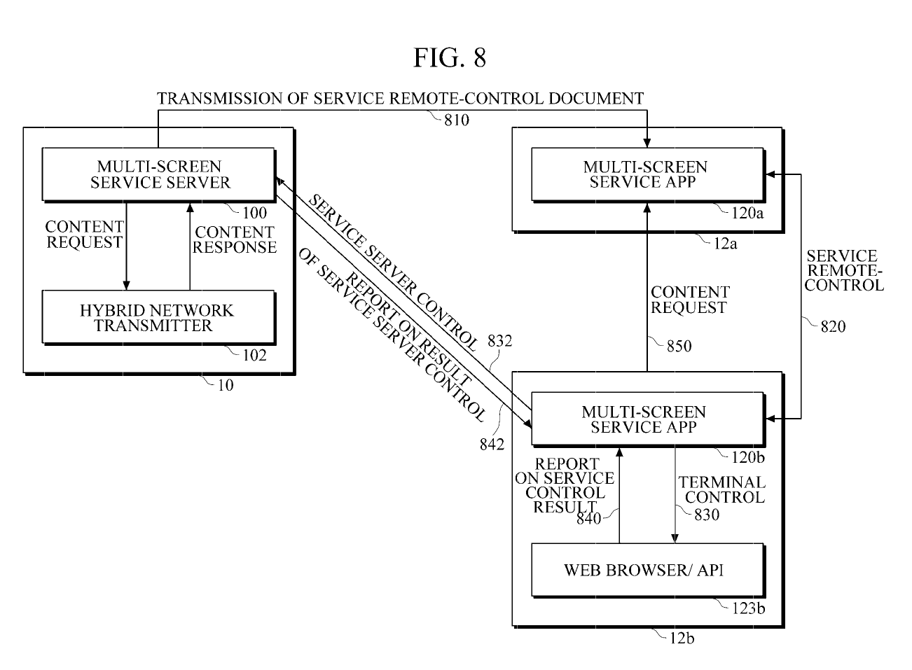

FIG. 8 is a flow chart illustrating a process for remote-controlling a multi-screen service according to an exemplary embodiment of the present invention.

Referring to FIG. 8, after being migrated from the mobile smart device 12a into the smart TV 12b, a multi-screen service on the smart TV 12b is remote-controlled by the mobile smart device 12a.

For a starter, after the multi-screen service is migrated, a multi-screen service server 100 transmits a document designed for remote-controlling the multi-screen service to the mobile smart device 12a in 810. A user controls the smart TV 12b using a multi-screen service App 120a of the mobile smart device 12a in 820. At this time, a multi-screen service API of a multi-screen service unit in each smart device may be responsible for the remote-control function. The service remote-control message includes a device control command, which is to control the smart TV 12b, including a volume control command, and a service-server control command, which is to control the multi-screen service server 100, including a content change command. The multi-screen service App 120b of the smart TV 12b controls a device control command via the web browser 123b which includes the multi-screen service API of the multi-screen service unit in 830, while transmitting a service-server control command to the multi-screen service server 100 to control the multi-screen service server 100 in 832. In response, the web browser 123b of the smart TV 12b, which includes the multi-screen service API, reports the device control result to the multi-screen service App 120b of the smart TV 12b in 840, while the multi-screen service server 100 reports the service-server control result to the multi-screen service App 120b of the smart TV 12b in 842. Next, a result of the service remote-control aiming to change a service status is reported to the mobile smart device 12a, and then service context is synchronized between the mobile smart device 12a and the smart TV 12b in 850.

According to an exemplary embodiment of the present invention, a user is able to receive a web-based multi-network adaptive multi-screen service. That is, the user may be provided with a multi-screen service via web-based multi-networks using whichever smart device that the user wishes to use. In addition, the user is able to migrate a piece of content from a specific smart device into a different one so as to enjoy the piece of content with the different device. Furthermore, the user may receive a multi-screen service with two or more smart devices simultaneously, and one of the smart devices may be used as a remote-controller for controlling a multi-screen service.

A multi-screen service provider is able to provide a multi-screen service adaptive to a network and a screen of the user's smart device. A multi-screen service developer may provide a User Interface (UI) and User Experience (UX) which are common to various web-based multi-screen services, as well as developing a multi-screen service independent from an Operating System (OS) of the smart device.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A smart device comprising:
a multi-screen service application (App) configured to execute a multi-screen service;
a web browser configured to communicate with a multi-screen server;
a multi-screen service unit included in the web browser;
an Application Programming Interface (API) included in the multi-screen service unit and configured to execute the multi-screen service; and
a hybrid network receiver configured to receive a piece of content from a multi-screen server via multi-networks.

2. The smart device of claim 1, wherein the multi-screen service means providing a service including the piece of content through a multi-screen, and the multi-screen is a group of screens belonging to a plurality of the smart devices.

3. The smart device of claim 1, wherein the multi-screen service unit comprises
a service discovery interface configured to discover a different smart device which provides the multi screen service on a same network as that of the smart device;
a service description exchange interface configured to help the smart devices to exchange a description about the multi-screen service;
a service migration interface configured to allow the multi-screen service to be migrated between the smart devices accessing the same network; and
a service remote-control interface configured to enables a source smart device to remote-control a multi-screen service which has been migrated to a target smart device.

4. The smart device of claim 3, wherein the service discovery interface discovers a multi-screen service provided by the different smart device, when the different smart device accessing the same network in the surroundings of the smart device receives a multicast advertisement message.

5. The smart device of claim 3, wherein the service discovery interface discovers the multi-screen service provided by the different smart device accessing the same network by periodically transmitting a multicast search message to request a search among surrounding smart devices and receiving a corresponding search response message.

6. The smart device of claim 3, wherein the multi-screen service Apps of the smart devices accessing the same network exchange a service migration request message and a migration response message with each other and transmit and/or receive the service migration request message with respect to the multi-screen service server.

7. The smart device of claim 6, wherein the hybrid network receiver receives a content request response message, comprising a URL of the requested piece of content, from the multi-screen service server through the multi-screen service App, and receives the request piece of content from the multi-screen service server with reference to the URL.

8. The smart device of claim 3, wherein a multi-screen service App of the source smart device transmits a service remote-control command to the target smart device to remote-control both the migrated multi-screen service and the target smart device, thereby enabling the source smart device to remote-control the multi-screen service which has been migrated into the target smart device.

9. The smart device of claim 8, wherein the service remote-control command comprises a device control command to control the target smart device and a service-server control command to control the multi-screen service server.

10. The smart device of claim 9, wherein a multi-screen service App of the target smart device transmits the device control command received from the source device to a multi-screen service unit thereof, and the multi-screen service unit controls the target smart device according to the device control command and reports a result of controlling the target smart device to the multi-screen service App of the target smart device.

11. The smart device of claim 1, further comprising:
a hierarchical decoder configured to decode a multiple-layered piece of content,
wherein the hybrid network receiver receives the multiple-layered pieces of content from the multi-screen service server via the multi-networks, synchronizes the received multiple-layered pieces of content, and then transmits the synchronized multiple-layered pieces of content to the hierarchical decoder.

12. A method for providing a multi-screen service in a smart device, the method comprising:
exchanging a service description about a multi-screen service by discovering the multi-screen service provided by a different smart device accessing a same network as that of a smart device;
requesting that the multi-screen service server migrate the multi-screen service and then receiving a content request response message comprising a URL of a requested piece of content to thereby continuously receive the requested piece of content currently being provided by the different smart device which has exchanged the service description; and
receiving the requested piece of content from the multi-screen service server via the multi-networks using the URL and reproducing the received piece of content.

13. The method of claim 12, wherein the exchanging of the description comprises discovering the multi-screen service provided by the different smart device, if receiving a multicast advertisement message from the different smart device which accesses the same network as that of the corresponding smart device.

14. The method of claim 12, wherein the exchanging of the description comprises discovering the multi-screen service provided by the different smart device by periodically transmitting a multicast search message to request a search among surrounding smart devices and receiving a corresponding search response message.

15. The method of claim 12, wherein the receiving of the content request response message comprises transmitting a service migration request message comprising service context, network information and a screen size of the multi-screen service to the multi-screen server, and then receiving the content request response message comprising the URL of the requested piece of content from the multi-screen service server.

16. The method of claim 12, wherein the reproducing of the piece of content comprises receiving a hierarchically-encoded multiple-layered piece of content from the multi-screen service server, decoding the hierarchically-encoded multiple-layered piece of content and reproducing the decoded piece of content.

17. The method of claim 12, wherein the reproducing of the piece of content comprises receiving a base layer via a broadcast network and an enhancement layer via a communication network, synchronizing the base layer and the enhancement layer, and decoding the synchronized base layer and the synchronized enhancement layer to thereby reproduce the piece of content.

18. A method for providing a multi-screen service in a smart device, the method comprising:
receiving a service remote-control command from a source smart device to control a different smart device;
controlling the smart device and a multi-screen service server according to the received remote-control command; and
transmitting to the source smart device a result of a service status changed by the control of the smart device and the multi-screen service server.

19. The method of claim 18, wherein the service remote-control command comprises a device control command to control the smart device and a service-server control command to control the multi-screen service server.
